(19) United States
(12) Patent Application Publication
(10) Pub. No.: US 2013/0016507 A1
(43) Pub. Date: Jan. 17, 2013

(54) D Shaped Induction Lamp Retrofit

(71) Applicant: John Yeh, Oxnard, CA (US)

(72) Inventor: John Yeh, Oxnard, CA (US)

(21) Appl. No.: 13/181,434

(22) Filed: Jul. 12, 2011

(51) Int. Cl. F21V 1/00; B23P 23/00

(52) U.S. Cl. 362/235; 29/401.1

(57) ABSTRACT

A retrofit for a conventional HID light fixture, used for either low bay or high bay applications. The retrofit replaces the conventional HID light fixture with an induction lamp system. The HID bulb within the dome is replaced with two D-shaped induction lamps. The HID ballast is replaced with two ballasts for each of the D-shaped induction lamp, and is preferably kept in the original ballast housing. It is possible to independently turn on and off as well as dim each of the two D-shaped induction lamps independently.

### FIELD OF THE INVENTION

This invention relates to a light fixture. In particular, it pertains to a light fixture that utilizes an induction lamp.

### DESCRIPTION OF RELATED ART

Large facilities such as warehouses, gyms, assembly areas, food processing plants, and hangers require special lighting applications to illuminate the facility. These facilities typically have very high ceilings, and thus the light fixtures are typically very high off the ground. Depending on the height of the light fixtures, there two general styles of light fixtures: low bay and high bay.

Low bay fixtures are typically used in areas where the bottom of the luminaire is less than twenty feet above the floor. These low bay fixtures conventionally utilize a dome reflector shape and HID for light output. The dome reflector for a low bay fixture is usually 20″-28″ in diameter, to allow the light to spread evenly. Traditional fluorescent fixtures may also be good for low bay lighting due to the low lumen requirement.

High bay fixtures are typically used where the bottom of the luminaire is more than twenty feet above the floor. Commonly, high bay fixtures also have a dome shaped reflector and HID for light output. The high bay dome shaped reflector differs from low bay dome shaped reflector in order to achieve better concentration of light output, and create a higher luminance. A high wattage lighting source is also required to achieve an adequate level of luminance to properly illuminate the space below.

HID lamps are a popular application with low bay and high bay lighting fixtures due to their high output per size, making them a compact and powerful. Some examples of HID lamps include mercury-vapor lamps, metal halide lamps, ceramic discharge metal halide lamps, sodium vapor lamps, xenon arc lamps, and UHP (Ultra-High Performance). For example, a high output metal halide lamp can be 400-watts and produce 41,000 lumens. In addition, 1000 watt and 1500 watt HID lamps are also available for general use. HID lamps do have some disadvantages, such as their lifespan, lumen depreciation over time, restrike time, flicker, glare, high operating temperature, and high mercury content.

Conventional fluorescent lamps are generally not a good alternative to HID for high bay use due to their relatively low lumen output. A fluorescent lamp known as T5 HO (high output) has gained some popularity due to its ability to output at a higher lumen relative to conventional T8 and T12 fluorescent lamps. A typical 54-watt T5HO produces 5000 lumens. These fluorescent lamps are linear tubes, and use a rectangular box style reflector. One of the most powerful T5HO luminaire is a 6 bulb fixture, which outputs 30,000 lumens at 360-watts.

An induction lamp is another alternative to HID and fluorescent lamps. Induction lamp is also known as electrodeless lamp. An induction lamp is a light source in which the power required to generate light is transferred from the outside of the lamp envelope by means of electromagnetic field. In contrast, a typical electrical lamp uses electrical connections through the lamp envelope to transfer power. Induction lamps have the advantage of a much higher life, and typically have a rated lamp life of 100,000 hours. HID lamps and T5HO typically have a rated lamp life around 20,000 hours. This means induction lamps can usually go 10 years without having to be changed out. The energy efficiency of induction lamp is typically about 140 lumens per watt. In contracts, the energy efficiency of a Metal Halide (HID) is about 110 lumens per watt and T5HO is about 90 lumens per watt. Induction lighting has an instant on capability (allowing for use with photocell and motion sensors), and does not flicker, strobe, or generate noise. The higher energy efficiency of an induction lamp typically results in lower operating temperatures. An induction lamp generally operates at less than 80 degrees F. Generally, a Metal Halide operates at over 300 degrees F., compact fluorescent operates at over 150 degrees F., and LED operates around 75-120 degrees F.

Light generated by different methods produce light of different qualities, and the human eye perceives this light differently. Scotopic vision is the human visual perception in low-light (night-vision), directed by the rod cells in human eyes. Photopic vision is the human color vision under normal conditions, during the day, directed by cone cells in the human eye. Mesopic vision is the combination between Photopic and Scotopic vision, taking into account the total sensitivity of the rod cells in the eye for blue range, with the color perception of the cone cells. Research has been conducted to better understand Mesopic vision, and more specifically, how Scotopic vision stimulates the photoreceptors, rods, in the human eye to cause pupil contraction and increase visual acuity. It was found that scotopically enhanced light appeared brighter even when light levels were reduced. The ratio of Scotopic light vs. Photopic light in a lamp is called P/S (or S/P) ratio. This ratio determines the apparent visual brightness of a light source. Induction lighting produces a high S/P ratio and this is why an 85 w induction lamp may appear as bright or brighter to the human eye than a sodium vapor or metal halide of twice the wattage. Visual Effective Lumens (VEL) is a key factor in vision and many traditional lumen meters will not measure this conversion factor accurately. The “pupil lumens” is encouraged to be used which factors in the P/S ratio. By using the pupil lumens of various lamp types, a more representative effective lumens perceived by the human eye can be measured. The general pupil lumen per watt for a Metal Halide is about 110, compact fluorescent is about 85, LED is about 75-120, and induction lamp is about 130-150.

As mentioned above, HID light fixtures have been and are a popular application for high bay and low bay lighting. There is a need for these HID light fixtures to be easily and economically upgraded to more efficient and higher quality lighting.

### BRIEF SUMMARY OF THE INVENTION

HID high bay and low bay light fixtures have long been and are still a popular lighting application. Herein is disclosed a retrofit system for a conventional HID light fixture to utilize a more efficient induction lamp, while preserving the desired effects of the light fixture. The HID bulb is replaced with two D-shaped induction bulbs held in place within the dome via brackets, and the HID ballasts are replaced with the appropriate induction lamp ballasts, and may continue to use the original ballast housing of the HID light fixture. This is designed to provide an economical and efficient means for replacing a HID lighting system with induction lighting.

### BRIEF DESCRIPTION OF THE DRAWINGS

A more complete appreciation of the invention and many of the advantages thereof will be readily obtained as the same becomes better understood by reference to the detailed description when considered in connection with the accompanying drawings, wherein:

FIG. 1 is a side view of a conventional HID light fixture.

FIG. 2a is a front view of an embodiment of a D shaped induction lamp.

FIG. 2b is a top plan of an embodiment of a D shaped induction lamp.

FIG. 2c is a rear plan view of an embodiment of a D shaped induction lamp.

FIG. 2d is a perspective view of an embodiment of a D shaped induction lamp.

FIG. 3 is a bottom view of an embodiment of a conventional HID fixture with two D shaped induction lamps.

FIG. 4 is a perspective view demonstrating an embodiment of how the two D shaped induction lamps are mounted into a conventional HID fixture.

FIG. 5 is a perspective view demonstrating an embodiment of how the two D shaped induction lamps are mounted into a conventional HID fixture.

FIG. 6 is a top perspective view of an embodiment of a HID fixture.

FIG. 7 is a top perspective view of an embodiment of a HID fixture with the ballast housing top portion removed.

FIG. 8 is a top perspective view of an embodiment of a HDI fixture with the ballast housing top portion disassembled.

### DETAILED DESCRIPTION

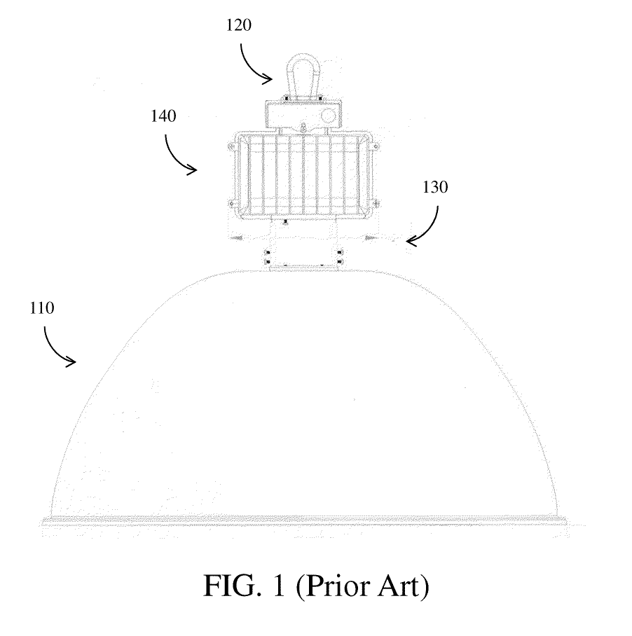

FIG. 1 shows a side view of the prior art, a HID light fixture which may be used for low bay or high bay applications. This HID light fixture is comprised of a dome 110, hook 120, ballast housing 140, and neck 130 between the dome 110 and ballast housing 140. There may be a junction box located above the ballast housing 140, or the junction box may be integrated within the ballast housing 140. The junction box may be utilized for wire termination. In this prior art example, the mounting is performed through the use of a hook 120, which is common, but may be substituted by various other well-known means of mounting. The hook 120 may be attached to the ballast housing 140 or a junction box if present. The dome 110 may be of various reflective materials, aluminum being popular.

The exact curvature of the dome 110 and diameter at the base varies based on the particular reflective and light distribution needs. For example, a HID light fixture intended for high bay use will have a more focused light distribution with a smaller diameter at the base than a HID light fixture intended for low bay use. The dome expects the HID bulb to be located generally in a central location of the dome so that the light source will achieve even light output within the internal walls of the symmetric reflective dome. The light source can be said to have a generally even or uniform light distribution within the internal walls of the dome. Each dome has its own photometric data characteristics, which is typically measured in candelas. The photometric data characteristics show the candelas at varying angles from the luminaire. Typically, the highest measured candela is directly underneath the luminaire, or at 0 degrees. There is typically little to no measurable candela at 90 degrees and above.

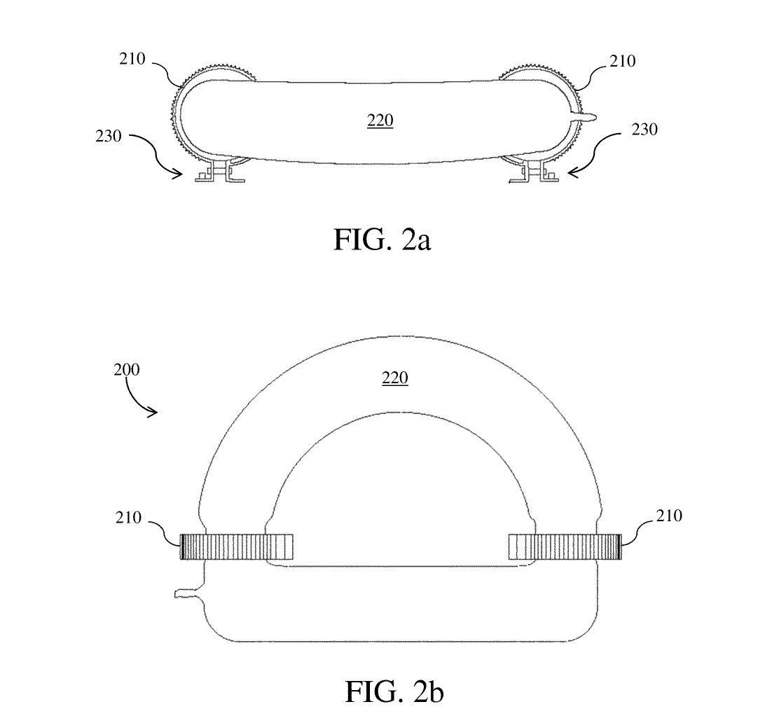

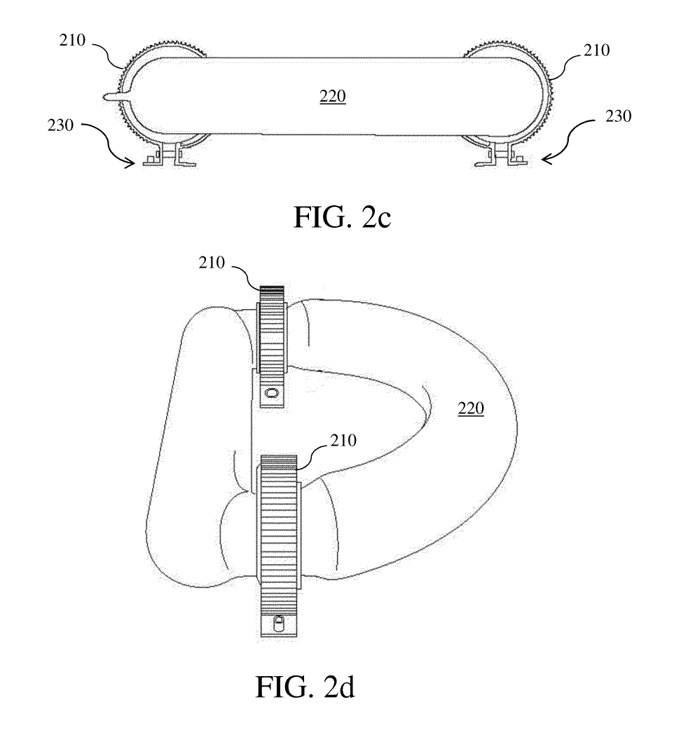

FIG. 2a through 2d are diagrams of a novel D shaped induction lamp. An induction lamp is also known as a magnetic induction lamp or electrodeless lamp. An induction lamp is typically comprised of a tube 220, filled with inert gas and a phosphor coating. There is an electromagnets 210 wrapped around a section of the lamp tube. High frequency energy from the electronic ballast (generator) is sent through wires, which are wrapped in a coil around a ferrite inductor, creating a powerful magnet. The induction coils 210 produce a very strong magnetic field which travel through the tube and excite the mercury atoms in the interior which are provided by a pellet of amalgam (solid mercury). The discharge path induced by the induction coils 210 forms a closed loop causing the acceleration of free electrons. The collision of the free electrons and mercury atoms result in the emission of UV light and, just as in a fluorescent tube, the UV light is up-converted to visible light by the phosphor coating on the inside of the tube. The typical induction lamp setups are a circular donut shape for use with an external ballast, racetrack (rectangular) shaped for use with an external ballast, and an exposed U shaped tube with a ballast base for screw in applications.

The D-shaped induction bulb has two mounting points 230, attached to each induction coil. This allows for the induction bulb to be screwed down to a stable base.

There is a desire to be able to retrofit a conventional HID light fixture with an induction lamp. However, there are a number of challenges in achieving a good solution for such a retrofit. Induction lamps generally do not achieve a wattage output to match a conventional HID lamp. For example, many HID lamps produce 400 W output, as well as 1000 W and 1500 W. Induction lamps typically achieve up to 300 W. Beyond 300 W, an induction lamp's coil tends to get unacceptably hot during normal operation. In addition, the electrical components in the ballast for an induction luminaire will typically overheat at a wattage beyond 300 W. This creates a challenge for retrofitting a HID light fixture with an induction lamp while producing a similar brightness.

Fortunately, induction lamps produce a higher pupil lumen per watt, which helps considerably. A 300 W induction lamp at 150 pupil lumens/watt will produce 300 W×150 pupil lumens/watt=45,000 pupil lumens. A 400 W metal halide lamp at 90 pupil lumens/watt will produce 400 W×90 pupil lumens/watt=36,000 pupil lumens. This translates to a single 300 W induction lamp being able to produce superior brightness (measured in pupil lumens) to a 400 W metal halide. A 1000 W metal halide at 90 pupil lumens/watt will produce 1000 W×90 pupil lumens/watt=90,000 pupil lumens. Thus, a single 300 W induction lamp will produce approximately half the pupil lumens of a 1000 W metal halide. Doubling the number of 300 W induction lamps will produce a comparable brightness (measured in pupil lumens) to a 1000 W metal halide.

If two induction lamps are to be used as a retrofit solution for a HID light fixture, a number of conditions need to be considered, including heat, size, and reflective qualities. When considering heat, it is feasible to use two induction lamps within a HID light fixture due to the significantly lower operating temperature of each induction lamp. The HID light fixture is generally designed to handle a heat tolerance high enough from two induction bulbs and two induction ballasts.

The next consideration is the size of the bulb. The induction bulb should fit within the dome of the HID light fixture. Fortunately, the dome of a HID light fixture is generally large enough to fit most curved induction bulbs. For example, it would be possible to use two racetrack or two donut shaped induction bulbs, stacked on top of one another, within a dome. The size of the ballast must also be considered, and will be discussed separately.

The third consideration is more complex and important as it affects the quality of the light output from the fixture. This third consideration is the reflective qualities. As discussed above, the dome of each HID light fixture has a particular photometric data characteristic. It is desirable to preserve these photometric data characteristics while producing the highest overall brightness possible. One option is stacking two donut shaped induction bulbs and placing them central within the dome to achieve generally even or uniform light distribution within the internal walls of the dome. However, this option has the disadvantage of the light output from the top of the lower induction bulb being blocked by the upper induction bulb. Similarly, the light output from the bottom of the upper induction bulb is blocked by the lower induction bulb.

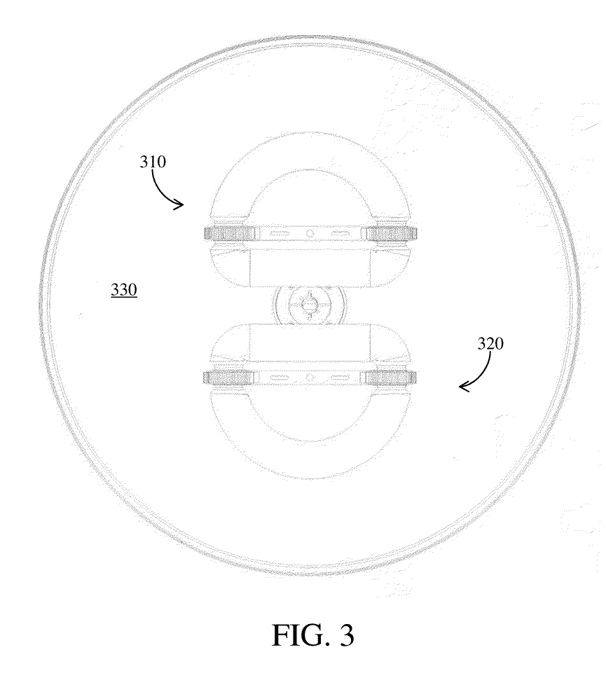

A novel and advantageous solution is to place two D-shaped induction bulbs 310 320 side by side, where the two D-shaped induction bulbs are essentially back to back at the elongated portions are back to back, with the curvature of each D-shaped induction bulb outward from one another. FIG. 3 demonstrates an embodiment, from a bottom view, showing how the two D-shaped induction bulbs 310 320 can be placed within the dome 330 of a conventional HID light fixture. The two D-shaped induction bulbs 310 320 are centrally located within the dome. The curved portion of the two D-shaped induction bulbs 310 320 generally follow a similar curvature to the dome 330 along the same plane. This setup generally achieves nearly even and uniform light distribution within the internal walls of the dome 330. In addition, there is minimal blockage of light between the two D-shaped induction bulbs 310 320. A gap between the two D-shaped induction bulbs 310 320 may exist to reduce the blockage of light.

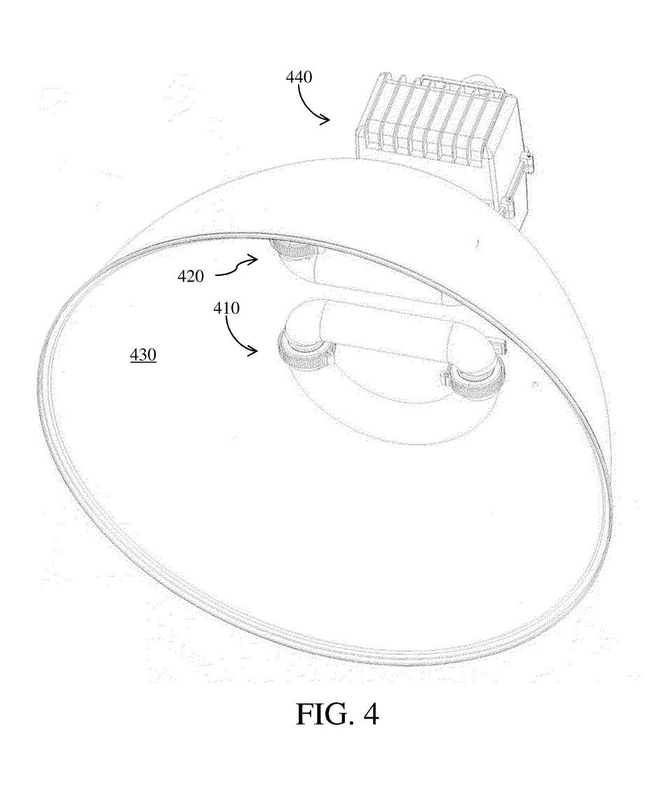

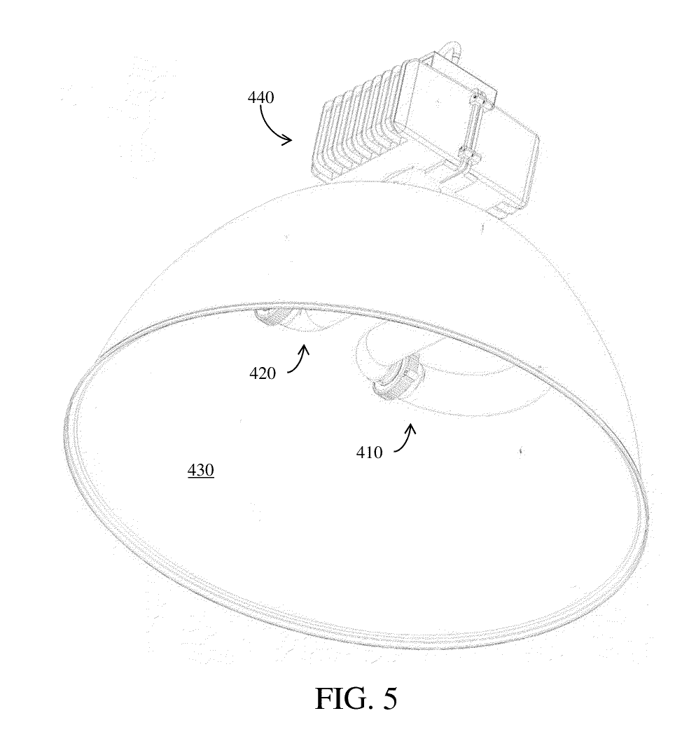

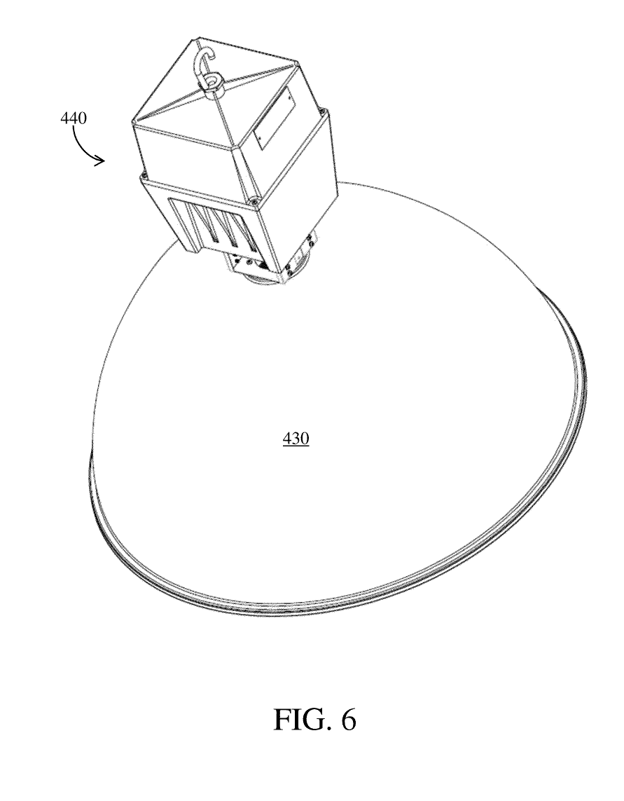

FIG. 4 and FIG. 5 are two perspective views of an embodiment of a HID light fixture retrofitted with two D-shaped induction lamps. The two induction bulbs are 410 420 are mounted within the dome 430 via brackets which attach at the mount points 230 of each induction bulb. Wiring from the induction bulbs 410 420 run up the top of the dome 430 through an opening that leads to the ballast housing 440.

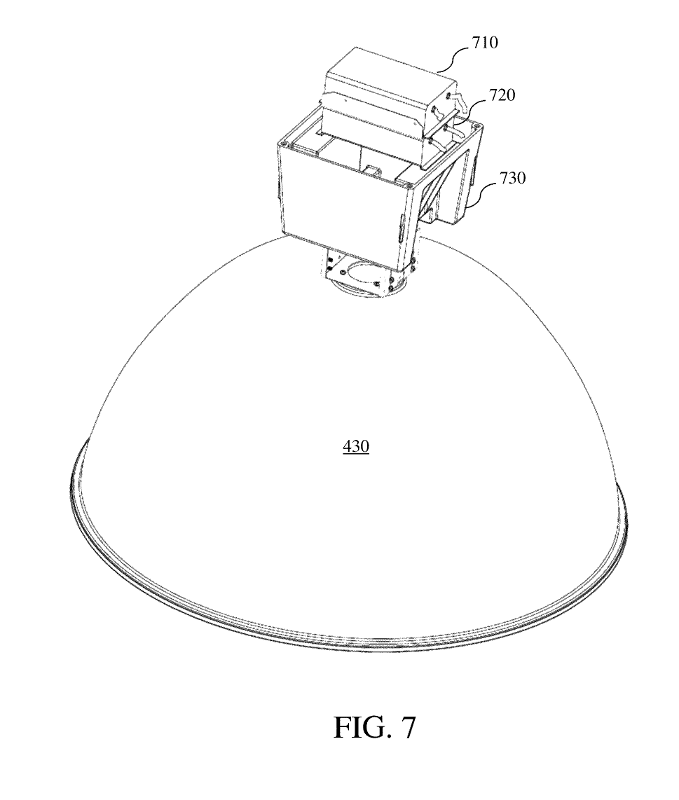

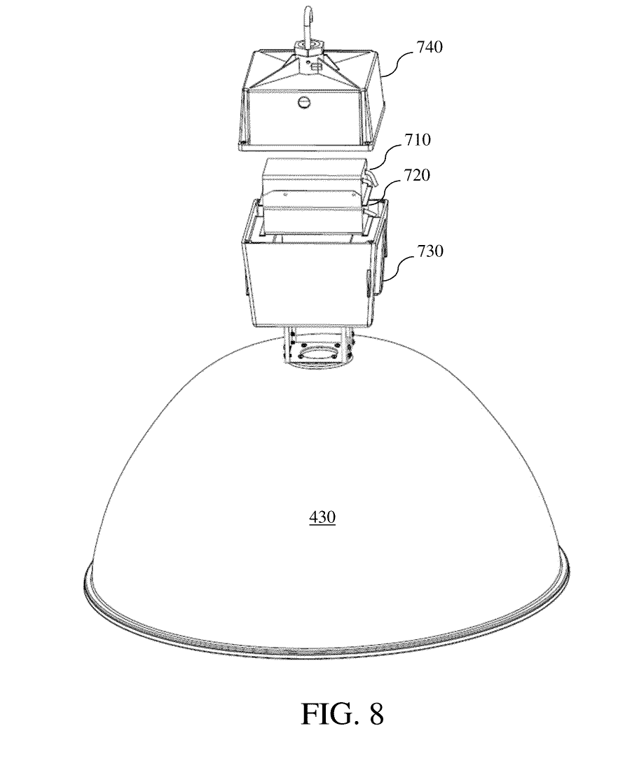

The HID ballast within the ballast housing 440, as seen in FIG. 6, must be replaced with ballast for an induction lamp. Since the HID fixture has been retrofitted with two D-shaped induction bulbs, each will require an induction lamp ballast. FIG. 7 demonstrates how two induction lamp ballasts 710 720 can be placed within the ballast housing 440. In this embodiment, the ballasts 710 720 are stacked on top of one another. The ballasts 710 720 may also be placed side by side or some other configuration. A bracket holds the two ballasts 710 720 together. The lower ballast 720 is fixedly attached to the bottom portion 730 of the ballast housing. FIG. 8 demonstrates the top portion 740 of the ballast housing fitting over the induction lamp ballasts 710 720.

With two D-shaped induction lamps, this lighting setup has the ability to turn each D-shaped induction lamp on individually. It is possible to turn on only one as opposed to both in order to conserve power and provide a limited brightness. A motion sensor can also be incorporated such that one D-shaped induction lamp is on regardless of the motion sensor, while the other D-shaped induction lamp is activated by the motion sensor. The D-shaped induction lamps may also be dimmable. Thus each of the two D-shaped induction lamps may be independently dimmed to the desired brightness.

The present invention has been described in an illustrative manner. It is to be understood that the terminology which has been used is intended to be in the nature of words of description rather than of limitation. While there have been described herein, what are considered to be preferred and exemplary embodiments of the present invention, other modifications of the invention shall be apparent to those skilled in the art from the teachings herein and, it is, therefore, desired to be secured in the appended claims all such modifications as fall within the true spirit and scope of the invention.

What is claimed is:

1. A light fixture comprising:
a dome;
a ballast housing interconnected at the top of said dome;
a pair of D shaped induction lamps positioned such that the linear portion of said induction lamps are parallel to one another and the curved portion of said induction lamps face outwards from one another, said pair of D shaped induction lamps mounted inside said dome; and
a first induction lamp ballast for one of said D shaped induction lamps and a second induction lamp ballast for the other of said D shaped induction lamps, wherein said first induction lamp ballast and second induction lamp ballast are housed within said ballast housing.

2. The light fixture of claim 1 wherein said pair of D shaped induction lamps are mounted inside said dome with a pair of brackets, said brackets fixedly attached to said dome and to said D shaped induction lamps.

3. The light fixture of claim 1 wherein said pair of D shaped induction lamps is mounted centrally within the vertical and horizontal plane of said dome.

4. The light fixture of claim 1 further comprising a first power switch for said first induction lamp ballast and a second power switch for said second induction lamp ballast, whereby each of said D shaped induction lamps may be turned on or off independent of the other.

5. The light fixture of claim 4 further comprising of a motion sensor to turn on said first power switch or said second power switch.

6. The light fixture of claim 4 wherein said first power switch and said second power switch have dimming capabilities.

7. A method of retrofitting a HID light fixture comprising the steps of:
replacing a HID lamp within a dome of said HID light fixture with a pair of D shaped induction lamps positioned such that the linear portion of said induction lamps are parallel to one another and the curved portion of said induction lamps face outwards from one another; and
replacing a HID ballast within a ballast housing of said HID light fixture with a first induction lamp ballast for one of said D shaped induction lamps and a second induction lamp ballast for the other of said D shaped induction lamps.

8. The method of retrofitting a HID light fixture of claim 7 wherein said step of replacing said HID lamp with said pair of D shaped induction lamps further comprises the substep of removing HID mounting brackets and installing an induction lamp bracket for each of said D shaped induction lamp, wherein said induction lamp bracket is fixedly attached to said dome and said D shaped induction lamp.

9. The method of retrofitting a HID light fixture of claim 7 wherein said step of replacing said HID lamp with said pair of D shaped induction lamps further comprises the substep of positioning said pair of D shaped induction lamps centrally within the vertical and horizontal plane of said dome.

10. The method of retrofitting a HID light fixture of claim 7 further comprising the step of wiring first induction lamp ballast to a first power switch and wiring second induction lamp ballast to a second power switch.

11. The method of retrofitting a HID light fixture of claim 10 wherein said first power switch and said second power switch have dimming capabilities.

12. The method of retrofitting a HID light fixture of claim 10 further comprising the step of wiring said first power switch or said second power switch to a motion sensor for turning on the power switch.
